(19) United States
(12) Patent Application Publication
(10) Pub. No.: US 2015/0184803 A1
(43) Pub. Date: Jul. 2, 2015

(54) PRESSURE TANK

(71) Applicant: Grzegorz Jarzynski, Radzyn Chelminski (PL)

(72) Inventor: Grzegorz Jarzynski, Radzyn Chelminski (PL)

(73) Assignee: Elpigaz Sp. z o.o., Gdansk (PL)

(21) Appl. No.: 14/404,504

(22) PCT Filed: May 31, 2012
(86) PCT No.: PCT/PL2012/050017

§ 371 Date: Jan. 26, 2015

(51) Int. Cl. F17C 1/08

(52) U.S. Cl. CPC F17C 1/08; F17C 2205/0323; F17C 2205/0352; F17C 2209/221

(57) ABSTRACT

A pressure tank, particularly an elongated toroidal tank, with various lengths in X, Y, Z axes, includes bottoms connected with more than one connector, equipped with fixture connector pipes, holders for installation of the tank and cover, fixture cover, internal bottoms, internal casings, partitions. The external upper bottom and the external lower bottom form an external shell of the tank, with cross-sections having the shape of a rectangle with rounded vertices, whereas the internal casings are connected with the internal bottomw and/or with the external bottoms, preferably connected by the internal bottomw with middle tubes forming internal central connectors of the tank, separated by partition, and connector pipes are welded to tank walls so that the thickness of the external pipe wall is between 0.4 to 1.8 of the thickness of the walls of the tank elements.

### BACKGROUND

1. Field

The invention relates to a pressure tank, particularly an elongated toroidal tank, especially a tank intended for gases in their volatile state, liquefied gases as well as liquids and mixtures thereof, and air, used in automotive vehicles, in rail vehicles, in machines, stationary or mobile equipment, as an integral component of a unit and/or as an independent unit.

2. Brief Description of Related Developments

The solutions for pressure tanks known to date are limited to the use of symmetrical structures in the form of toroidal tanks (with equal axial lengths), cylindrical tanks, twin tanks being a combination of two cylindrical tanks connected by intermediate elements, or mutually overlapping, duo tanks being a combination of two cylindrical tanks with the same diameter, or various diameters, with interpenetrating casings.

International patent application PCT No. WO9846443 discloses a flat tank for liquefied gas, wherein two interconnected bottoms, an upper one and a lower one, have conical upper and lower flanges welded in centrally, connected with one another via a pipe with openings located uniformly on its perimeter.

Also, Polish application description No. P-354299 discloses a tank for gas, particularly liquefied petroleum gas, the tank consisting of interconnected, profiled upper bottom and a profiled lower bottom, as well as a profiled middle tubular part, wherein the middle tubular part has two pass-through holes and two additional bottoms closing the tubular part, while one of the bottoms has a connector pipe. The tank is characterised in that in one of the additional middle bottoms, a valve with a pipe in the vertical axis of the tank, with precisely defined height in relation to the bottom is installed.

Polish application description No. P-384134 and the international patent application PCT No. WO 2009082250 (A1) disclose a four-bottom tank, forming preferably a toroidal tank, comprising interconnected bottoms, equipped with fixture connector pipes, holders for installation of the tank and its cover, a fixture cover, a central connector with holes and a middle bushing, characterised in that it consists of at least four tightly interconnected bottoms, of which the external upper bottom and the external lower bottom form an external shell of the tank, while the internal upper bottom, connected with the internal lower bottom via a middle bushing and preferably an internal casing with holes, form a central connector, comprising an additional workspace.

### SUMMARY

The pressure tank according to the invention, particularly the elongated toroidal tank, with various lengths along the X-, Y-, and Z-axis of a Cartesian coordinate system, comprising bottoms connected with more than one connector, equipped with fixture connector pipes, holders for installation of the tank and its cover, a fixture cover, internal bottoms, internal casings, partitions, is characterised in that the external upper bottom and the external lower bottom form an external shell of the tank in the form of a solid with cross-sections having the shape of a rectangle with rounded vertices, while the internal casings are connected with the internal bottoms and/or with the external bottoms, preferably connected by the internal bottoms with the middle tubes, forming internal central connectors of the tank, preferably separated by a partition. The fixture connector pipes are welded into elements of walls of the tank so the thickness of the external part of the pipe wall is in the range between 0.4 and 1.8 of the thickness of walls of tank elements.

Preferably, the internal casing of the tank has a form of a seamed tube or a seamless tube, or a bushing formed of a coiled sheet strip or connected sheet strips, or a cone or a truncated cone, a cylinder with a bottom or a bottomless cylinder, which may be straight or curled up. Internal bottoms or the bottoms of which the internal casings will be made, and/or the partition, preferably have the form of spherical segments with various radii or with more than one radius, and/or truncated cones with various base and top diameters, and with various inclination angles of the walls in relation to the base of the cone with a pressed top or a welded-in top, or a top not closed with any surface, and/or cylinders with welded-in or pressed bottoms to form a cylinder with a bottom in the form of a flat disc or a formed ring.

In a basic embodiment of the invention, as a result of combination of proper design of the internal upper and lower bottoms with one another and with middle parts in the form of connectors, consisting of internal casings, and/or connected internal bottoms and/or middle tubes, an elongated toroidal tank is obtained. In a second embodiment of the invention, an internal casing is welded in between the external bottoms, the upper one and the lower one, connected with more than one internal central connector. Preferably, the internal bottoms and/or the internal casings and/or the middle tubes of the tank constitute parts of a tight chamber for the second working medium, and/or and a space for placement of the pressure tank or a container for storage of the second working medium.

Preferably, at least one internal central connector is welded in between the external bottoms: the upper one and the lower one.

In another embodiment of the invention, at least one central connector is closed tightly from the top with an upper cover, and from the bottom—with a lower cover, forming tight chambers of the second working medium.

Equipping the tank with a fixture for one and/or two working media, installed in the internal bottom and/or in the internal casing, and/or in the covers, is contained within the limiting outlines of external surfaces of the tank defined by the surfaces of the external bottoms, the upper one and the lower one, and/or by the external casing.

Preferably, in the elements forming the internal walls of the tank: in the internal casings of the connectors and/or in the internal partitions and/or in the internal bottoms, cup-shaped holes are located, forming ducts in places of the holes, the ducts having length greater than the thickness of the wall.

Preferably, the middle tube is of a multi-layer form, consisting of several tubes interconnected coaxially and inseparably.

The multi-layer middle tube has a structure consisting of from 2 to n seamed tubes or seamless tubes, whereas the external diameter of the smaller tube is close to the internal diameter of the larger tube with tolerances enabling placement of the smaller tube inside the larger tube, wherein the tubes are then connected with one another in the entire perimeter or in its part from one side or from both sides.

In another embodiment of the tank according to the invention, the shape of the walls of the direct fixture housing connected inseparably or separably, from the side of the walls of the tank, projects the shape of curvatures of the walls of the tank, while the direct fixture housing equipped with a cover with a seal, is connected separably with the walls of the tank using bolts and latches and tightened by the seal.

Preferably, the partition is equipped with holes with various shapes and sizes and/or complete movable partitions, which preferably have holes with various shapes and sizes.

In their entire circumference or in its part, external edges of the partition are connected with the internal walls of the pressure tank to divide the space inside the pressure tank into 2 chambers at minimum in a way preventing flow of the working medium in the liquid phase between the partitions at the height from the bottom of the tank to the nearest edge in the partition. In another embodiment of the tank according to the invention, the tank is equipped with a system for maintaining minimum levels between the chambers, the system consisting of intermediate ducts in the form of pipes and/or conduits connecting the spaces of the tank chambers, and/or setting and/or a flow controller.

In further embodiment of the tank according to the invention, the tank is equipped with a quick dismantling system for the tank fixtures, the system consisting of an additional chamber, containing at least one connector pipe for the tank fixtures, a cut-off valve for the flow of the working medium from the tank to the additional chamber, and cut-off valve control.

Owing to a proper design of the bottoms and their connection via more than one connector (middle tube), the pressure tank according to the invention has various side lengths, and enables a better utilisation of the space with various side lengths (along the X-, Y-, and Z-axis), in which the tank is to be placed. Storage of two various working media allows for using one tank for two various working media (mixtures of these media) in vehicles and other bi-fuel systems, the media being stored separately, instead of using two different tanks for each of the working media separately which was the case until now. A proper selection of thicknesses of the individual tank elements, structural solutions of the components (proper design of the external bottoms, multi-layer tubes, fixture connector pipes, cup-shaped holes, partitions) provides a larger volume increase at bursting of the tank reached at lower pressures, in relation to close equivalents of similar structures of special tanks (elliptical, twin, duo, toroidal). The design of the elongated toroidal tank improves the handling safety of the tank by a larger volume increase before bursting, or a higher value expressed by a ratio of a volume increase percentage before bursting to the pressure in which bursting of the tank occurs; it allows for decreasing the tank bursting pressure and for a reduction of the amount of material used for manufacture of the tank with close external dimensions (overall dimensions), volume, working parameters and application.

Through a proper selection of the shape and thicknesses of the walls of particular tank elements, the described solution of the elongated toroidal tank and other pressure tanks enables changes in values expressed by a ratio of a volume increase percentage before bursting to the pressure in which bursting of the tank occurs—that is the values of the volume increase obtained under defined tank bursting pressures, changes in the bursting pressures of the tank structure depending on requirements for the individual applications of the tank and the required volume increase before bursting and/or the discharge of the tank contents to the outside.

The design of the connector pipe according to the invention, used in pressure tanks, enables a flexible operation of the tank structure, particularly in the range of high pressures close to the tank bursting pressures, and enables application of metal sheets and materials with a lower thickness value than with the solutions used to date, resulting in economic advantages. Owing to the application of a connector pipe according to the invention, a larger volume increase at a bursting test for a given tank structure is obtained, while compared (related) to the designs of the connector pipe used to date. A larger volume increase at a bursting test allows for a large extension of the series of types of the pressure tanks and their application ranges.

The increase in the cross-section of the working medium flow through the holes in the tank elements forming the walls between the individual parts of the tank located in the internal casings and/or in the internal bottoms and/or in the external partitions and a reinforcement of the walls in the places where the holes are made, is obtained thanks to cup-shaped holes. A cup-shaped hole increases the tensile strength of an element of the tank structure in the case of tension resulting from the pressures occurring in a closed pressure tank, enabling reduction of the thickness of the walls of the tank elements transmitting the tensile stresses, through which the working medium flows.

Owing to application of multi-layer middle tubes, a reduction of the thickness of the entire element as a uniform one is obtained, leading to a reduction of the material weight while increasing the strength parameters. A system for quick fixture (equipment) dismantling of the pressure tank, enabling the pressure tank equipment dismantling without the necessity to empty the tank of the working medium stored under pressure and/or without a reduction of the pressure

A tank according to the invention may be installed together with a proper fixture equipment in any plane, from a horizontal position and a vertical position, to a suspended position, depending on the operational needs and way of utilisation.

### BRIEF DESCRIPTION OF THE DRAWINGS

The subject of the invention is illustrated in its embodiments in the drawings, where

FIG. 1 shows a cross-section of the elongated toroidal tank,

FIG. 2—a cross-section of the elongated toroidal tank in the embodiment with an internal casing,

FIG. 3—view W from FIG. 1,

FIG. 4 (A, B, C, D)—a cross-section of the middle of the tank for the embodiments,

FIG. 5—a cross-section of the tank through its middle part with a multi-layer tube and cup-shaped holes in the internal casing,

FIG. 6—a cross-section of the tank in the embodiment with partitions,

FIG. 7—a side view of the tank in the embodiment with fixture connector pipes and with the fixture housing placed as an example,

FIG. 8—view Z from FIG. 7,

FIG. 9—a cross-section of the tank with a system for maintaining the given minimum levels of the working medium between the chambers,

FIG. 10—a cross-section of the tank with a chamber in the internal connector L, intended for the second working medium (B),

FIG. 11 (A, B, C)—a cross-section through a connection of a fixture connector pipe with the tank elements,

FIG. 12—the system for maintaining the given minimum levels of the working medium between the chambers,

FIG. 13—a system for quick fixture dismantling without emptying the tank of the working medium, and/or without a reduction of its pressure.

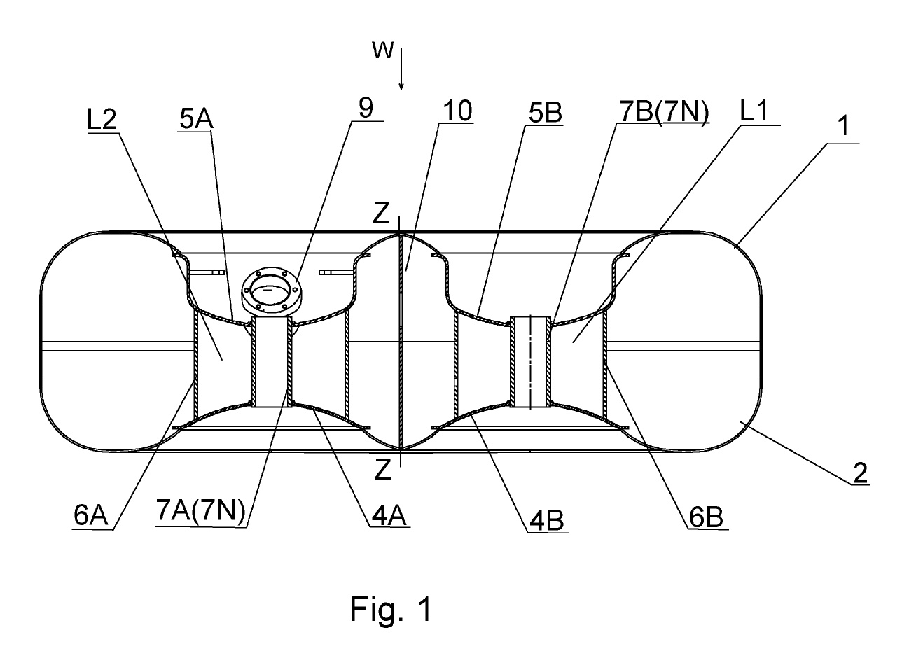

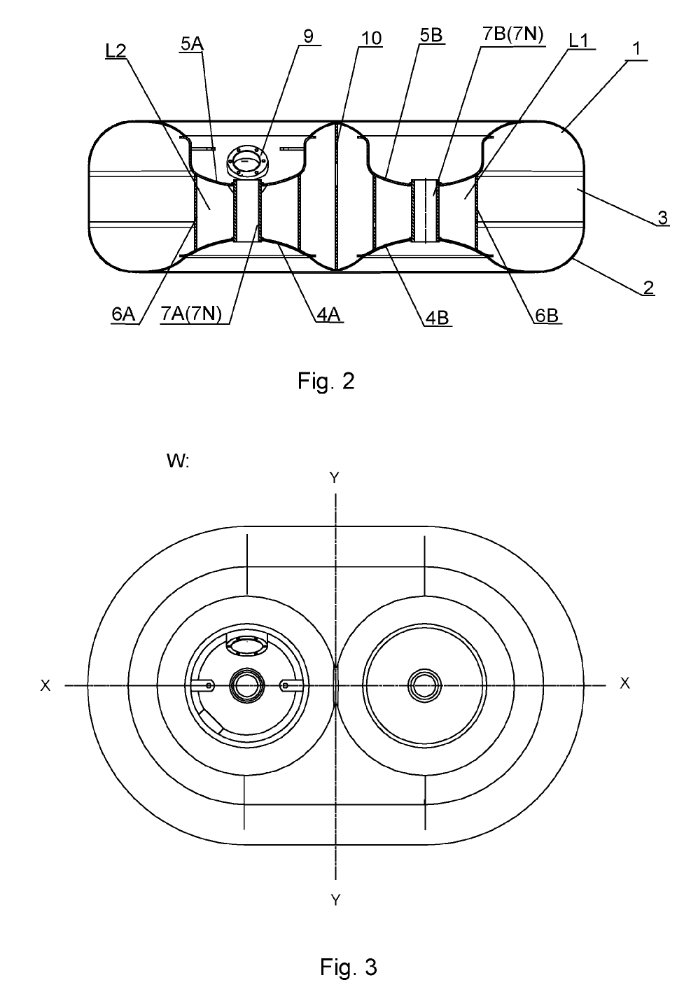

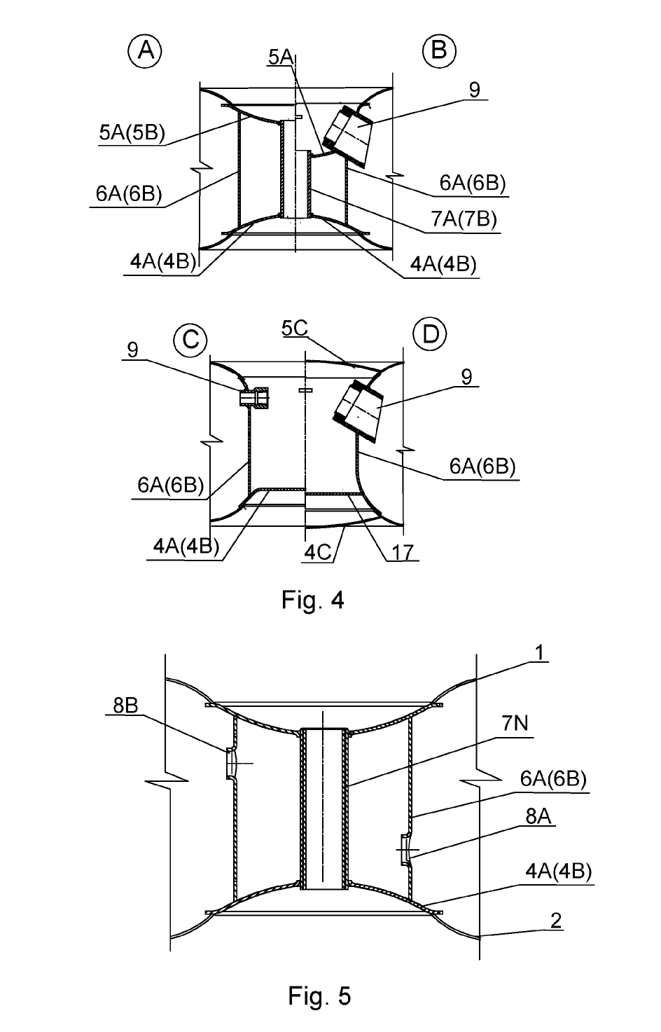

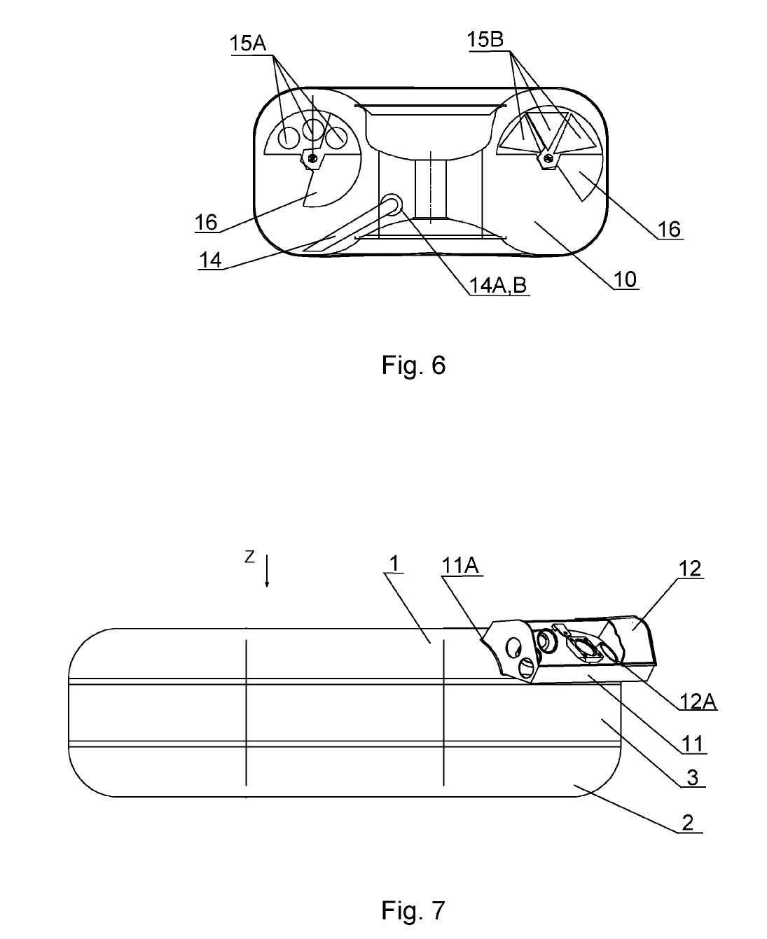

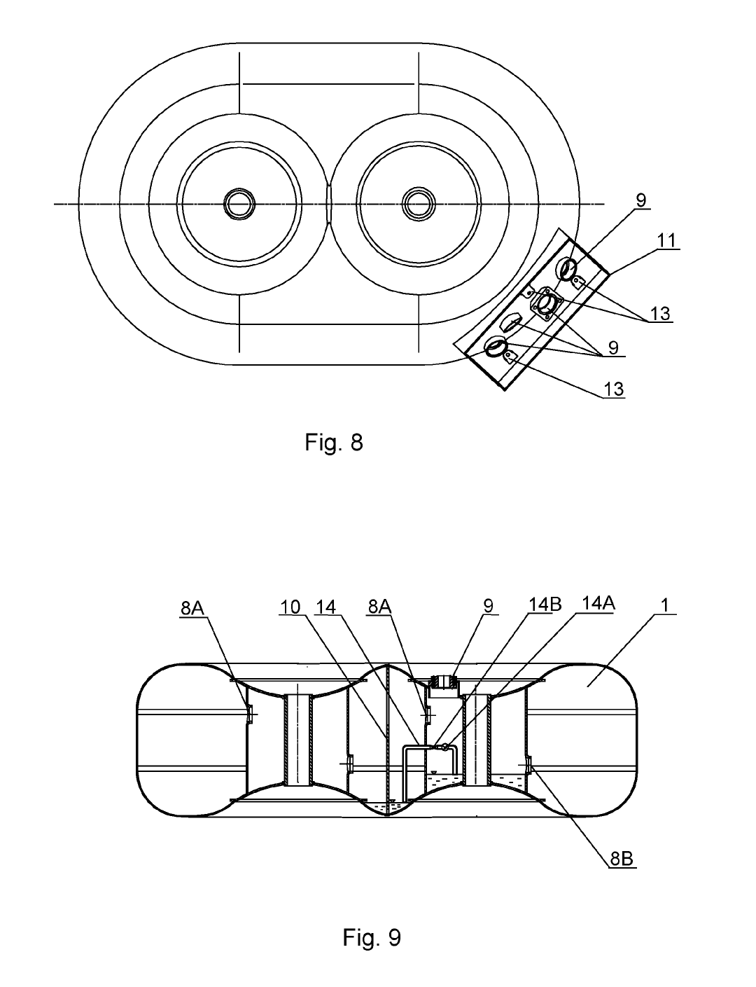

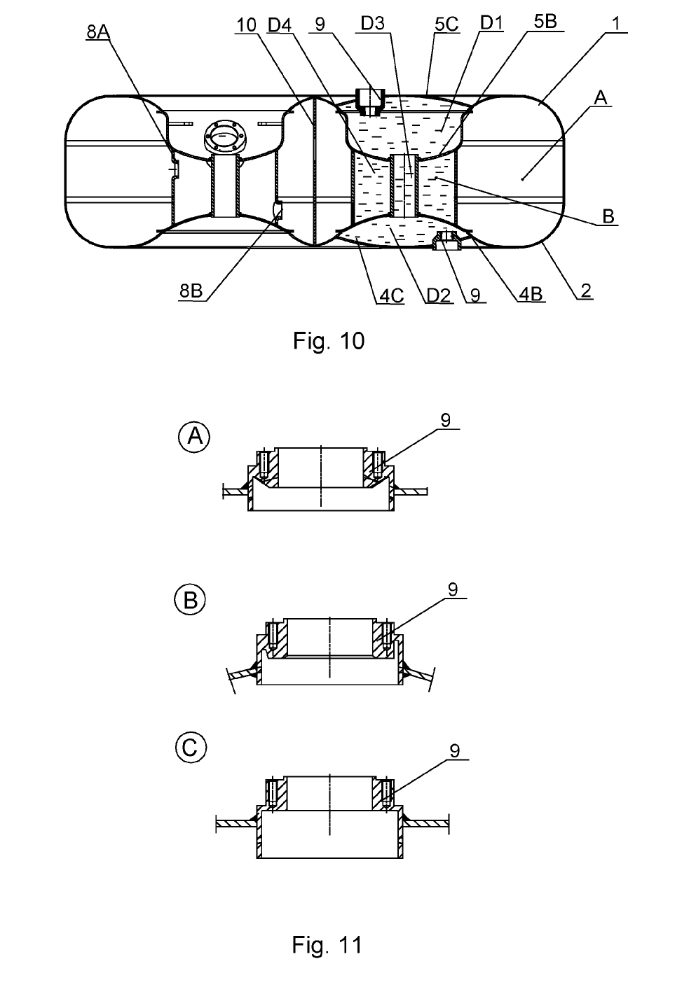

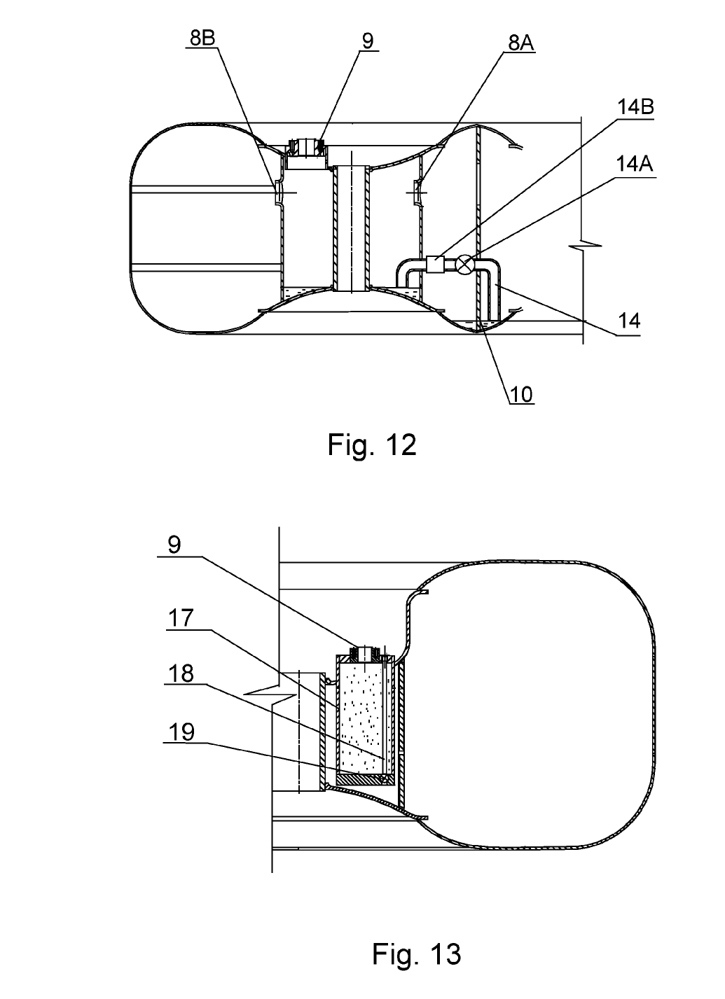

### DETAILED DESCRIPTION OF THE DISCLOSED EMBODIMENTS

The external upper bottom 1 and the external lower bottom 2 form an external shell of the tank in the form of a solid figure with cross-sections having the shape of a rectangle with rounded vertices, while internal casings 6A, 6B are connected with the internal bottoms 4A, 4B, 5A, 5B and/or with the external bottoms 1, 2, preferably connected by the internal bottoms with the middle tubes 7A, 7B, 7N, forming internal central connectors L1, L2 of the tank, and/or preferably separated by a partition 10. The fixture connector pipes 9 are welded into elements of walls of the tank so as to the thickness of the external part of the pipe wall is in the range between 0.4 and 1.8 of the thickness of the walls of the tank elements.

In a second embodiment of the invention, an internal casing 3 is welded in between the external bottoms, the upper one 1 and the lower one 2, connected with more than one internal central connector.

The internal bottoms (4A, 4B, 5A, 5B) and/or internal casings (6A, 6B) and/or the middle tubes (7A, 7B, 7N) of the tank constitute parts of a tight chamber for the second working medium (B) and/or space for placement of the pressure tank or a container for storage of the second working medium (B). At least one internal central connector (L1, L2) is welded in between the external bottoms: the upper one (1) and the lower one (2).

In further embodiment of the tank, at least one central connector L1, L2 is closed tightly from the top with an upper cover 5C and from the bottom—with a lower cover 4C, forming a tight chamber (D1 and/or D2, and/or D3, and/or D4) of the second working medium B.

Preferably, equipment of the tank with a fixture for one and/or two working media A and B, installed in the internal bottom 4A, 4B, 5A, 5B and/or in the internal casing 6A, 6B, and/or in the covers 4C, 5C, is contained within the limiting outlines of external surfaces of the tank defined by the surfaces of the external bottoms, the upper one 1 and the lower one 2, and/or by the external casing 3.

In the elements forming the internal walls of the tank: in the internal casings 6A and/or 6B of the connectors L1 and/or L2, and/or in the internal partitions 10, and/or in the internal bottoms 4A, 4B, cup-shaped holes 8A, 8B are located, forming ducts in places of the holes, the ducts having length greater than the thickness of the wall.

The middle tube 7N is of a multi-layer form, consisting of several tubes interconnected coaxially and inseparably.

The shape of the walls of the direct fixture housing connected inseparably or separably 11, from the side of the walls of the tank, projects the shape of the curvatures of the walls of the tank.

The direct fixture housing 11 equipped with a cover 12 with a seal 12A, is connected separably with the walls of the tank using bolts and latches 13, and tightened by the seal 11A.

Preferably, the partition 10 is equipped with holes 15A and 15B with various shapes and sizes and/or complete movable partitions 16 which preferably have holes with various shapes and sizes.

In another embodiment, the tank is equipped with a system for maintaining minimum levels in the chambers, the system consisting of intermediate ducts 14 in the form of pipes and/or conduits connecting the spaces of the tank chambers, and/or setting 14B, and/or a flow controller 14A.

In further embodiment a tank is equipped with a quick dismantling system for the tank fixtures, the system consisting of an additional chamber 17 containing at least one connector pipe for the tank fixtures, 9, a cut-off valve 19 for the flow of the working medium from the tank to the additional chamber 17, and the cut-off valve 19 control 18.

1. A pressure tank, particularly an elongated toroidal tank, with various lengths along X-, Y-, and Z-axis of a Cartesian coordinate system, comprising bottoms connected with more than one connector, equipped with fixture connector pipes, holders for installation of the tank and its cover, a fixture cover, internal bottoms, internal casings, partitions, wherein the external upper bottom and the external lower bottom form an external shell of the tank in the form of a solid with cross-sections having the shape of a rectangle with rounded vertices, whereas the internal casings are connected with the internal bottoms and/or outer with the external bottomws, preferably connected by the internal bottoms with middle tubes, forming internal central connectors of the tank, preferably separated by a partition, while the fixture connector pipes are welded into elements of walls of the tank so that the thickness of an external part of the pipe wall is in the range between 0.4 to 1.8 of the thickness of the walls of the tank elements.

2. A pressure tank according to claim 1, wherein an external casing is welded in between the external bottoms; the upper one and the lower one, connected with more than one internal central connector.

3. A pressure tank according to claim 1, wherein the internal bottoms and/or the internal casings and/or the middle tubes of the tank constitute parts of a tight chamber for a second working medium and/or a space for placement of the pressure tank or container for storage of the second working medium.

4. A pressure tank, according to claim 1, wherein at least one internal central connector is welded in between the external bottoms: the upper one and the lower one.

5. A pressure tank, according to claim 1, wherein at least one central connector is closed tightly from the top with an upper cover and from the bottom with a lower cover, forming tight chambers a second working medium.

6. A pressure tank, according to claim 1, wherein equipment of the the tank with a fixture for one and/or two working media, installed in the internal bottom and/or in the internal casing and/or in the covers, is contained within the limiting outlines of external surfaces of the tank defined by surfaces of the external bottom, the upper one and the lower one and/or by the external casing.

7. A pressure tank, according to claim 1, wherein in the elements forming the internal walls of the tank: in the internal casings of the connectors and/or in the internal partitions and/or in the internal bottoms, cup-shaped holes are located, forming ducts in places of the holes, the ducts having length greater than the thickness of the wall.

8. A pressure tank, according to claim 1, wherein the middle tube has a multilayer form consisting of several tubes interconnected coaxially and inseparably.

9. A pressure tank, according to claim 1, wherein the shape of the walls of the direct fixture housing connected inseparably or separably from the side of the walls of the tank, projects the shape of the curvatures of the walls of the tank.

10. A pressure tank, according to claim 8, wherein the direct fixture housing, equipped with a cover with a seal, is connected separably with the walls of the tank using bolts and latches and tightened by a seal.

11. A pressure tank, according to claim 1, wherein the partition is equipped with holes with various shapes and sizes and/or movable partitions, which preferably have holes with various shapes and sizes.

12. A pressure tank, according to claim 1, wherein it is equipped with a system for maintaining minimum levels between chambers, the system consisting of intermediate ducts in the form of pipes and/or conduits connecting spaces of the tank chambers, and/or setting and/or flow controller.

13. A pressure tank, according to claim 1, wherein it is equipped with a quick dismantling system for the tank fixtures, the system consisting of an additional chamber, containing at least one connector pipe for the tank fixtures, a cut-off valve for the flow of a working medium from the tank to the additional chamber, and a cut-off valve control.
